(19) United States
(12) Patent Application Publication
(10) Pub. No.: US 2016/0292679 A1
(43) Pub. Date: Oct. 6, 2016

(54) TRANSPORT MONITORING

(71) Applicant: UBER Technologies, Inc., San Francisco, CA (US)

(72) Inventors: Benjamin Kolin, Sunnyvale, CA (US); Derrick Ongchin, San Mateo, CA (US); Bennett Woo, Palo Alto, CA (US); Chee Yu, Dublin, CA (US)

(21) Appl. No.: 14/678,656

(22) Filed: Apr. 3, 2015

(51) Int. Cl. G06Q 20/40; G01C 21/20; G06Q 50/30

(52) U.S. Cl. CPC G06Q 20/40; G06Q 50/30; G01C 21/20

(57) ABSTRACT

A system can determine that a service has been initiated for a user by a service provider. During performance or progress of the service, the system can receive location data points from a computing device operated by the user or the service provider and detect an occurrence of an event in connection with the service based on one or more of a set of received location data points, or an elapsed amount of time since the initiation of the service. In response to detecting the occurrence of the event, the system can determine a score that enables the transport to be monitored for unauthorized overuse.

### BACKGROUND

In a typical online transaction, a purchaser of a good or a service can submit an order to an online merchant using a computing device, such as a personal computer. A payment gateway can communicate with the purchaser's credit card company, for example, to authorize the purchaser's credit card on behalf of the online merchant. For a good that is ordered by the purchaser, this communication typically occurs when the purchaser finalizes the order, whereas for a service that is performed by a provider, this communication typically occurs after the service is completed and the purchaser charges an amount to the purchaser.

### BRIEF DESCRIPTION OF THE DRAWINGS

FIG. 1 illustrates an example system to perform one or more authorization processes during performance of a service, under an embodiment.

FIG. 2 illustrates an example method of performing one or more authorization processes during performance of a service, according to an embodiment.

FIGS. 3A through 3C illustrate other example methods of performing one or more authorization processes during performance of a service, under an embodiment.

FIGS. 4A and 4B are example diagrams illustrating authorization processes, according to embodiments.

FIG. 5 is a block diagram that illustrates a computer system upon which embodiments described herein may be implemented.

FIG. 6 is a block diagram that illustrates a mobile computing device upon which embodiments described herein may be implemented.

### DETAILED DESCRIPTION

According to examples described herein, a system can implement multiple authorization processes during the course of a given user's utilization of transportation resources, in order to ensure the user's continuous use of the service does not result in unauthorized over-usage. The authorization processes can utilize input data recorded by location (e.g., Global Positioning System device) or other sensor-based components that are carried within transport resources (e.g., carried by user, driver or in transport vehicle) in which the user that is being authorized is located in. Among other benefits, embodiments as described can enable partial authorization of transport resources using location and/or sensor information provided by travelers. An authorization action can be performed for just the portion of the transport (i.e., exclusively), rather than the whole transport. Such partial authorization can be repeated as needed to ensure that the travelers do not exceed an authorized limit when information about the authorization limit of the traveler is unknown, and further when parameters for evaluating the trip (e.g., final destination, route taken, intervening events) against the authorization limit are also unknown.

According to some embodiment, the authorization limit of the traveler is determined as a score. In the context of travel, the score can be based on parameters that include distance traveled and time to travel. Other factors which can affect score can include location-based tolls or other events which are predetermined to affect the score.

In some variations, the authorization limit can be determined by using a third party authorization source. For example, the determined score for the user can be submitted to the authorization source. By way of example, the score can correspond to a fare (e.g., monetary value) or a percentage of allocation for a period of time. The authorization source can correspond to, for example, an account authorization source (to clear funds) or controller of the allocated resources.

In some examples, the system can correspond to a service arrangement system that coordinates a service to be provided for a requesting user by a service provider. As the service is being provided (e.g., while the service is ongoing or not yet complete), the system can monitor the progress of the service and based on data pertaining to the service, can perform incremental authorization processes in connection with the user's account. As one example, the system can secure funds from the user's account for a time before completion of the service, thereby preserving the ability to collect at least some amount for the service on behalf of the service provider. As described herein, an authorization process can correspond to the system determining an authorization amount for an ongoing transport service, transmitting an authorization request to an authorization source (e.g., which can be an independent source), and/or receiving information indicating whether preceding and/or additional resource allocation of the transport service is authorized.

In one example, the system can determine that a transport service has been initiated for a user (e.g., a rider) by a service provider (e.g., a driver of a vehicle). During the progress of the transport service, the system can receive location data from a device carried in the transport vehicle (e.g., the service provider's device and/or the user's device_{—} and can detect an occurrence of an event in connection with the transport service based on (i) a set of received location data points and/or (ii) an elapsed amount of time. In response to detecting the occurrence of the event, the system can determine an authorization score (e.g., a monetary amount) for the transport service based, at least in part, on a set of parameters associated with the transport service. The system can then transmit an authorization request to hold an open transaction for an authorization amount for the user's financial account. If the authorization succeeds, this can ensure that at least the authorization amount can be collected by the system (at a later time) when the transport service is completed.

In some examples, the authorization source can correspond to a user's financial account which is valid account (e.g., one that has funds associated with it and/or identified by the financial account company as not being stolen/misappropriated), but also a low-limit payment instrument (e.g., a debit card that is backed by an account with only five dollars on it, or a credit card having an available credit limit of only five dollars). In such examples, if the system transmits, to the payment processing system, an authorization request to hold an open transaction for an authorization amount that is greater than five dollars for the user's financial account, the payment processing system can determine that the transaction cannot be held. Alternatively, if, after the service was initiated, the financial account company determines that the account associated with the user has been stolen or misappropriated, the financial account company can flag the account as such. When the system transmits the authorization request at a later time, the payment processing system can determine that the transaction cannot be held after communicating with the financial account company. When the authorization fails, the system can receive information about the failure from the payment processing system, and in response, can transmit a message to the service provider's device instructing the service provider to end the service for the user.

According to examples, the system can perform an authorization process numerous times (e.g., incremental processes) during the transport service, such as each time a predefined event is detected. Depending on implementation, an event in connection with the transport service can correspond to (i) the vehicle (or the driver or rider) having traveled a threshold distance, such as a predetermined distance from the start location where the transport service started or a predetermined distance from the location of the vehicle when the previous event, if any, was detected, and/or (ii) the transport service being provided for a threshold duration of time, such as a predetermined duration of time since the start time of the transport service or a predetermined duration of time since the time when the previous event, if any, was detected. Each time the system detects an event as the transport service progresses, the system can determine an authorization score that is based, at least in part, on that event and transmit an authorization request for authorization (e.g., to hold an open transaction for an amount that is based on the score). As the transport service continues and the distance traveled increases (and/or the duration of the transport service increases), the total amount held can also continue to increase, thereby enabling the system to maintain authorization for the transport being provided (e.g., an amount of funds).

In some examples, the system can determine an authorization amount in relation to a detected event by computing an amount for a fare of the transport service as of the time the event was detected. For example, the system determine the distance traveled by the vehicle from the start location of the transport service to the location of the vehicle at the time the event was detected and/or determine the duration of time elapsed from the start time of the transport service to the time the event was detected. Based on the set of parameters associated with the transport service, the system can compute a score for the transport provided. Alternatively, the system can estimate a total score for the transport being requested as of the time the event was detected based on, for example, historic data that is associated with the geographic region where the transport was initiated, the vehicle type associated with the transport service, the day (and/or time of day) in which the transport service is being provided, the route in which the transport service is being provided, and/or other historic data.

As used herein, a user/rider or client device, a service provider device or driver device, a computing device, and/or a mobile device refer to devices corresponding to desktop computers, cellular devices or smartphones, personal digital assistants (PDAs), laptop computers, tablet devices, etc., that can provide network connectivity and processing resources for communicating with the system over one or more networks. Client devices and driver devices can each operate a designated service application (e.g., a client application and a driver application, respectively) that is configured to communicate with the system. A driver device can also correspond to a computing device that is installed in or incorporated with a vehicle, such as part of the vehicle's on-board computing system.

Still further, examples described herein relate to a variety of services, such as a transport service, a food truck service, a delivery service, an entertainment service, a house cleaning service, etc., or generally, any on-demand service or any variable-priced service and/or post-paid transaction between a user and a service provider or provider of goods. For purpose of simplicity, the examples described herein are in reference to a transport service for moving a person or item from one location to another. In some examples, the system can be implemented or operated by any entity that provides goods or services for purchase or arranges for goods or services to be purchased through the use of computing devices and network(s).

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines shown with examples described herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### System Description

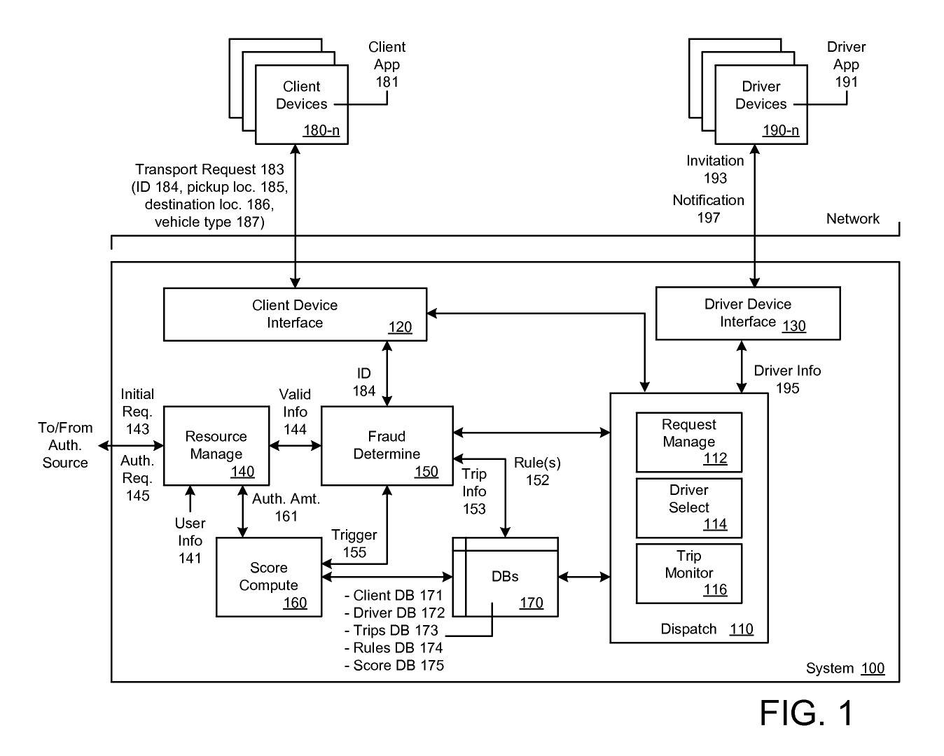

FIG. 1 illustrates an example system to perform one or more authorization processes during performance of a service, under an embodiment. According to an example, a service arrangement system 100 (also referred to herein as the system 100) includes a dispatch 110, a client device interface 120, a driver device interface 130, a resource manage 140, a fraud determine 150, a score compute 160, and a plurality of databases 170 (or other data stores). The plurality of databases 170 can include, for example, a client database 171, a driver database 172, a trips database 173, a rules database 174, a price database 175, and other databases. A plurality of client devices 180 and a plurality of driver devices 190 (e.g., service provider devices) can communicate with the system 100 over one or more networks using, for example, respective designated service applications 181, 191 that are configured to communicate with the system 100. The components of the system 100 can combine to perform authorization actions processes using an authorization source of the system 100 or user (e.g., a user's account). In performing the authorization action or process, the authorization requested can be made exclusive to (e.g., just for) a portion of the transport in progress (e.g., preceding segment of transport, or anticipated segment of transport). Logic can be implemented with various applications (e.g., software) and/or with hardware of a computer system that implements the system 100. Because the components described in FIG. 1 are an illustrative example of the system 100, in some examples, one or more of the components of the system 100 (e.g., the resource manage 140, the fraud determine 150, the score compute 160, etc.) can be a part of the dispatch 110.

Depending on implementation, one or more components of the system 100 can be implemented on network side resources, such as on one or more servers. The system 100 can also be implemented through other computer systems in alternative architectures (e.g., peer-to-peer networks, etc.). As an addition or an alternative, some or all of the components of the system 100 can be implemented on client devices, such as through applications that operate on the client devices 180 and/or the driver devices 190. For example, a client service application 181 and/or a driver service application 191 can execute to perform one or more of the processes described by the various components of the system 100. The system 100 can communicate over a network, via a network interface (e.g., wirelessly or using a wireline), to communicate with the one or more client devices 180 and the one or more driver devices 190.

The system 100 can communicate, over one or more networks, with client devices 180 and driver devices 190 using a client device interface 120 and a device interface 130, respectively. The device interfaces 120, 130 can each manage communications between the system 100 and the respective computing devices 180, 190. The client devices 180 and the driver devices 190 can individually operate client service applications 181 and driver service applications 191, respectively, that can interface with the device interfaces 120, 130 to communicate with the system 100. According to some examples, these applications can include or use an application programming interface (API), such as an externally facing API, to communicate data with the device interfaces 120, 130. The externally facing API can provide access to the system 100 via secure access channels over the network through any number of methods, such as web-based forms, programmatic access via restful APIs, Simple Object Access Protocol (SOAP), remote procedure call (RPC), scripting access, etc.

According to examples described herein, the system 100 provides a platform to enable users of client devices 180 to request services, such as transport services, through use of respective client applications 181. The system 100 can receive a transport request from a client device 180, process the transport request by selecting a driver to provide the transport service (also referred to herein as a “trip”) for the requesting user or rider, and invite the selected driver to provide the trip. For example, the system 100 can receive a transport request 183 from a client device 180 of a user or rider, via the client device interface 120. The transport request 183 can include a user identifier (ID) 184, a pickup location data point 185 (or a pickup address), a destination location data point 186 (or destination address), and/or a vehicle type 187 (e.g., a category or class of vehicles that the user wants to be transported in). Information such as the pickup location data point 185 and destination location data point 186 can be obtained using sensor information on either a user device or a device associated with the transport provided or vehicle.

### Initial Authorization Process

In one example, after receiving the transport request 183, the system 100 can perform an initial authorization process to determine the user is authorized to receive transport from the system 100. For example, the user's account can be checked to determine if it active or valid. For example, in one implementation, the fraud determine 150 can receive the user ID 184 from the transport request 183, access the client database 171 to identify a user's account using the user ID 184, and identify the user's account (e.g., from a payment profile that is associated with a financial account of the user) on which to perform the initial authorization check on. As an addition or an alternative, multiple authorization profiles can be associated with a user's account, with each payment profile including information of a user's financial account (e.g., a credit card, a debit card, a bank account, a gift card, an online payment method, etc.). For example, the user can associate the user's account with multiple payment methods or financial accounts by inputting the corresponding payment information (e.g., name, account numbers, card numbers, expiration dates, etc.) via the service application 181. The user can select a payment profile to use to pay for the transport service and an identifier corresponding the user-specified payment profile (or a default payment profile, if not user-specified) can be transmitted along with the transport request 183. The system 100 can perform the initial authorization check on the financial account identified from the transport request 183.

The fraud determine 150 can communicate with the resource manage 140 to perform an initial authorization process of the user's financial account (and one or more subsequent authorization processes). According to an example, the resource manage 140 can communicate with a payment processing system (not shown in FIG. 1) over one or more networks. As described herein, a payment processing system can correspond to system that provides a payment gateway, provides a financial account information storage (e.g., stores accounts numbers for users), and/or authorizes financial accounts and processes transactions (e.g., exchanges funds between accounts). Such a payment processing system can be operated by (i) an entity that implements or operates the system 100, (ii) a third-party entity that provides the payment processing services on behalf of the entity by communicating with issuers of financial accounts, or (iii) an issuer of the financial account, such as a credit card company or a bank.

According to some examples, when the fraud determine 150 triggers the resource manage 140 to initiate the initial authorization process, the resource manage 140 can determine, e.g., from the user information 141 (from the user's account), the user's financial account information. The resource manage 140 can transmit an initial authorization request 143 to the payment processing system to check whether the user's financial account is valid. The payment processing system can communicate with the respective issuer of the user's financial account (e.g., the corresponding credit card company) to determine whether the financial account is valid by requesting a small value amount authorization on the financial account (e.g., a $0 or $1 authorization amount). If the financial account is valid (e.g., not flagged as being stolen or misappropriated, and/or has available funds associated with it), the issuer can validate the financial account and the payment processing system can transmit information about its validity (e.g., valid bit or message, or invalid bit or message) to the resource manage 140. On the other hand, the issuer can notify the payment processing system that the financial account is invalid.

The resource manage 140 can receive information about the validity of the financial account from the payment processing system, and transmit the corresponding validation information 144 to the fraud determine 150. The validation information 144 can indicate whether the user's financial account is valid or invalid. If the result of the initial authorization process indicates that the financial account is invalid, the fraud determine 150 can transmit, via the client device interface 120, a message to the client application 181 of the user's device 180 informing that the transport request 183 cannot be processed (and/or requesting the user to provide a valid financial account). The initial authorization process can occur before the dispatch 110 performs a driver selection process, thereby enabling the system 100 to conserve computational resources if the user's financial account is invalid. Alternatively, if the fraud determine 150 determines, from the validation information 144, that the user's financial account is valid, the fraud determine 150 can cause the dispatch 110 to process the transport request 183 and perform a driver selection process for the user.

In some examples, the system 100 can perform an initial authorization process each time a user makes a transport request 183 using a respective client application 181. As an addition or an alternative, the system 100 can perform an initial authorization process for a user when it receives the transport request 183 only under certain conditions. For example, the fraud determine 150 can determine the last date and/or time the initial authorization process for performed for the user's financial account. If the fraud determine 150 determines that the initial authorization process was performed within the last predetermined amount of time and the user's financial account was determined to be valid, the fraud determine 150 can instruct the resource manage 140 to skip the initial authorization process when the transport request 183 is received from the user's device 180. The fraud determine 150 may have marked a flag or stored information in or with the user's account to indicate when the initial authorization was last performed successfully and on which financial account of the user. Still further, in another example, the system 100 can perform an initial authorization process for only those users who are identified as being potentially fraudulent or suspected to be fraudulent based on fraud scores associated with those users' accounts.

### Fraud Determination

As described herein, a potentially or suspected fraudulent user may create a user account and use the account in a manner that defrauds an entity that provides the system 100. A potentially or suspected fraudulent user may defraud the system 100 by ordering and/or paying for goods or services using falsified information (e.g., a fake name, a fake address, etc.) or misappropriated payment methods (e.g., stolen credit cards, credit card numbers, misappropriated bank account information, etc.), by improperly taking advantage of promotions for the user's financial gain, by using the system 100 and the client application 181 to perform illicit actions, and/or by breaching agreements or licenses under which the user agreed to use the client application 181 to communicate with the system 100. In addition, a potentially or suspected fraudulent user may use a financial account having a low-limit payment amount. According to some examples, the system 100 can use information associated with a user account and historical information about past services requested and/or rendered in order to determine whether the user account is associated with a potentially fraudulent user. As described herein, a user account associated with a potentially fraudulent user is also referred to as a “potentially fraudulent user account.”

In one example, the fraud determine 150 can use information associated with the user account, such as previously stored behavioral information about the user and transports services requested and received by the respective user, to determine, for individual user accounts, whether that user account is a potentially fraudulent user account. For example, for each user account (of some or all user accounts stored in the client database 171), the fraud determine 150 can determine a score that is indicative of fraud (e.g., a fraud score) based on information associated with that user account. The fraud determine 150 can determine a fraud score based on one or more fraud rules 152 or parameters from the rules database 174. The fraud rules 152 can specify what factor(s) to use to compute the fraud score and what weights (e.g., such as a multiplier or percentage to apply to a factor) to apply to what factor(s) to compute the fraud score. Weights can cause one factor to influence the fraud score more heavily than another factor. A fraud rule 152 or parameter can also specify the threshold fraud score. Still further, in some examples, a fraud rule 152 or parameter can specify when or how often the fraud determine 150 is to determine the fraud score for individual user accounts (e.g., periodically every day or every week, or every time a trip is requested or completed for a user account, etc.). The fraud rules 152 or parameters can be configured by a user of the system 100.

The factors that are used by the fraud determine 150 can correspond to information associated with a user account or other information derived from such information. For example, the factors used to determine the fraud score for a user account can include (i) a time when the user account was created (or a duration of time since the corresponding user signed up), (ii) the number of times the user added, deleted, or modified payment methods, (iii) the number of times a payment method was declined, (iv) the amount of money spent by the corresponding user (e.g., total amount spent, amount spent over the last specified duration of time, or amount spent within a specified duration), (v) the geographic location of the user or geographic regions where the user typically requests and/or receives transport services (e.g., the pickup and/or destination locations, whether the locations or addresses correspond to landmarks of interest, etc.), (vi) the geographic location of the user as compared to the billing address or geographic location corresponding to a payment method, (vii) whether the contact information of the user has been verified (e.g., the mobile phone number or email address), (viii) the lengths and/or prices of the transport services received (e.g., durations and/or distances of the trip), (ix) the number of times promotions are used by the corresponding user, (x) whether another user account exists that share the contact information as the account (e.g., same phone number or email address or home or billing address, etc.), (xi) whether a payment method was provided by the corresponding user using the image capture process, (xii) whether a payment method has been flagged as being a stolen or misappropriated payment method or as having insufficient funds, and/or other information associated with the user account or trips requested by and/or provided for the corresponding user.

Based on the fraud rules 152 or parameters, for each user account, the fraud determine 150 can determine one or more of the factors associated with that user account, apply weight(s) to the one or more factors, and compute a fraud score. The fraud determine 150 can then compare the fraud score, which can be a value (e.g., zero to one hundred, or a percentage), to a default or threshold fraud score. If the fraud score for the user account is equal to or greater than the threshold fraud score, the fraud determine 150 can determine that the user account is associated with a potentially fraudulent user, and mark or flag the user account as being a potentially fraudulent user account.

As an addition or an alternative, the system 100 can perform operations in connection with transport services for individual users based on whether or not those users are potentially fraudulent users. According to some examples, when the system 100 receives a transport request 183, the fraud determine 150 can check the user account associated with the user that make the transport request 183 to determine whether the user is a potentially fraudulent user. If the user is a potentially fraudulent user, the fraud determine 150 can cause the system 100 to operate in a secondary mode for at least the duration of the transport service for that user, such as a funds preservation mode, so that additional precautionary operations are performed by the system 100. When the system 100 operates in a funds preservation mode for a user or for the user's transport service, the system 100 can detect an event in connection with the transport service, determine an authorization amount in response to detecting the event, and transmit an authorization request to hold a transaction for the amount to a payment processing system before completion of the transport service. On the other hand, if the user is not a potentially fraudulent user, the fraud determine 150 can operate in a default, primary operation mode as compared to the secondary mode. When the system 100 operates in the default, primary operation mode for a user or for the user's transport service, the system 100 does not perform any authorization processes during the progress of the trip.

Alternatively, the system 100 can perform operations corresponding to the funds preservation mode for any, some, or all users, as opposed to just those that are identified as being potentially fraudulent. In another example, the system 100 can perform operations corresponding to the funds preservation mode for sets of users that are in a predetermined geographic locations or sets of users that make transport requests during a predetermined frame of time.

### Authorization Process

When the user makes a transport request 183, the dispatch 110 can process the transport request 183 for the user, e.g., provided that the user's financial account was validated (or provided that the fraud determine 150 indicates that the user's financial account was validated within the last predetermined amount of time). For example, the dispatch 110 can include a request manage component 112 that receives the transport request 183 (or some or all of the information from the transport request 183). The request manage component 112 can determine the user-specified information from the transport request 183, and the driver select component 114 can select a driver for the user based on the pickup location data point 185, the destination location data point 186, the vehicle type 187, and/or driver information from the driver database 172 (e.g., such as the drivers' or driver devices' current locations and statuses).

For example, the dispatch 110 can periodically store information about drivers' locations and statutes in the driver database 172 received from driver devices 190. The driver select 114 can select a driver to provide the transport service for the user by selecting, for example, an available and on-duty driver driving a vehicle that satisfies the vehicle type 187 and that is closest (by distance or shortest estimated travel time) to the pickup location data point 185. The dispatch 110 can transmit, via the driver device interface 130, an invitation 193 to the selected driver's device 190 and the corresponding driver application 191 can display information about the transport service to the driver. The driver can provide input on the driver application 191 to either accept the invitation 193 or reject the invitation 193.

When the driver accepts the invitation 193, the trip monitor component 116 can receive information indicating the driver's acceptance and determine that the transport service has been arranged for the user. The trip monitor 116 can create a trip entry in the trips database 173 corresponding to the transport service and store information about the transport service (e.g., referred to herein as trip information) in the trip entry. Once the trip is arranged for the user, the trip monitor component 116 can monitor the status and progress/performance of the transport service, such as where the driver is relative to the pickup location, by receiving driver information 195 from the selected driver's device 190 through use of the driver service application 191 (e.g., periodically and/or intermittently in response to receiving driver input). In other examples, the location information of vehicle (and corresponding timestamp) during the transport service can be provided by the client device 180. The driver information 195 can include the current location data point generated by the driver device 190, the driver ID, and/or the status information of the driver or driver application 191.

In some examples, the trip monitor 116 can also detect when the transport service has been initiated for the user by the driver. In one example, the trip monitor 116 can receive information from the driver application 191 when the driver provides input indicating that the transport service has started. In another example, the trip monitor 116 can detect when the client device 180 of the user and the driver device 190 of the driver are within a predetermined distance of each other for at least a predetermined duration of time, based on location data received from the respective devices. The trip monitor 116 can record, in the trip entry, the start location of the transport service and the associated time when the transport service was initiated.

The trip monitor 116 can also update the trip entry and/or driver database 172 with the received driver information 195 as the transport service progresses. The trip entry can include trip information, such as the user ID, the client device ID, the driver ID, the driver device ID, the vehicle type, the pickup location (e.g., start location), the time for pickup (e.g., the start time), the location data points corresponding to the travel of vehicle, etc., and once the transport service is completed at a later time, can also include the time for drop off, the route taken, the duration of the transport service (e.g., ten minutes), pricing information (e.g., default amount per minute and/or default amount per distance, and/or dynamically adjusted multiplier for increasing or decreasing the default price(s)), the price for the trip (e.g., a dollar amount), or other trip information. In this manner, the system 100 can use some or all of the location data points received during the progress of the transport service (and/or the time information associated with the location data points) to determine the status of the transport service, such as the route the driver has driven, how far the vehicle has traveled from the start location, how long the transport service is taking, the rate of travel, the rate at which the fare for the transport service is increasing or decreasing, etc.

After the transport service is initiated, during the progress of the transport service, the trip monitor 116 can update the driver database 172 with the driver information 195 periodically from the driver device 190 or alternatively, update the trip entry for the transport service using the driver information 195 periodically received from the driver device 190. The fraud determine 150 can periodically use trip information 153 of the transport service from the trip entry or from the driver database 172 to determine when, if any, to perform an authorization process in connection with the user's financial account. As an addition or an alternative, the fraud determine 150 can receive trip information 153 from the trip monitor 116 or the driver device 190 via the driver device interface 130. Because the trip information 153 can indicate the start location and/or the start time, and the subsequent location data points of the transport service received from the driver device 190, the fraud determine 150 can determine, based on a set of received location data points, and/or time information in connection with the transport service, whether an event has occurred in connection with the transport service. If an event has occurred, the fraud determine 150 can perform or trigger the system 100 to perform an authorization process. If no event is detected during the progress of the transport service and the transport service completes, then no authorization process is performed by the system 100 during the transport service. In such example, the system 100 can calculate a score for the transport service after completion based on the start location, the destination location, the duration of the transport service, and/or the set of parameters associated with the transport service. The parameters for determining the score can include (i) a distance (e.g., distance traveled or will be traveled), (ii) time, (iii) service type (e.g., vehicle type) and/or (iv) weights or values that are predetermined for specific events or conditions (e.g., overall demand at a particular time). Other examples of score parameters are provided below. The score can, for example, correspond to a fare, or form the basis a resource provisioning.

According to some examples, events in connection with a transport service can be specified by event rules 152 from the rules database 174. An event can indicate when the fraud determine 150 is to perform an authorization process for individual user accounts during the transport service. The event rules 152 can be configured by a user operating the system 100, such as by interacting with a user interface to provide inputs specifying location data points, distances, times, etc. for events. In one example, an event can correspond to a predetermined distance traveled by the driver or vehicle from a start location (e.g., ten miles) or from a previous location associated with a previously detected event. In another example, an event can correspond to a duration of time that the transport service has been continuing since the start time (e.g., twenty minutes) or since a previous time when a previous event was detected. Another example of an event can correspond to a distance being traveled and also an amount of time elapsing (e.g., at least fifteen miles and at least twenty five minutes). Still further, in another example, an event rule(s) 152 can cause the fraud determine 150 to perform authorization processes periodically (e.g., perform an authorization process every ten minutes or fifteen minutes), randomly (e.g., based on a random number generator associated with a time or distance), based on a set schedule, or based on a particular rate of travel or a rate at which the fare (e.g., dollar amount) of the transport service is increasing or decreasing.

According to other examples, an event can be based on both the start location and the destination location, if provided by the user or the driver. The event can specify that the fraud determine 150 is to determine the predicted distance of travel or the predicted travel time for the transport service based on the start and destination locations, and if the predicted distance or predicted travel time is greater than a threshold distance or threshold travel time, respectively, to perform an authorization process at a specified time (after the start time), e.g., at the estimated quarter completion or halfway point of the transport service. In another example, an event can be associated with a geographic region, such as a defined geofence (e.g., that is identified by three or more location data points). The geographic region can correspond to a region that is known to be a bad neighborhood (e.g., one that is associated with high amounts of fraudulent activity). Such an event can cause the fraud determine 150 to perform an authorization process when it detects that the vehicle has entered the geographic region or has been traveling within the geographic region for a predetermined duration of time.

In some examples, events can be associated with a particular geographic region, so that transport services that started in one geographic region can be subject to different distance/time triggering events as compared to transport services that started in another geographic region. As an addition or an alternative, events can be associated with particular conditions associated with the transport service, such as the current dynamic pricing multiplier (e.g., whether the price that is associated with the transport service is at a default price, such as 1× multiplier, or a threshold multiplier price, such as 3× multiplier) or a particular vehicle type. Such events can be useful to cause authorization processes to occur more frequently at threshold distances or times (e.g., three miles, or eight minutes) for potentially high-priced transport services, which are transport services that are typically requested by potentially fraudulent users. An example of a high-priced transport service can correspond to a more luxurious or spacious vehicle type or a cheaper, smaller vehicle type having a high price multiplier (e.g., 2.5X of the default price) at the time the transport service is requested.

Referring back to FIG. 1, for an individual transport service that is in progress, the fraud determine 150 can detect when an event in connection with the transport service has occurred based on one or more of a set of received location data points and/or an elapsed amount of time since the transport service had started. In this example, the event can cause the system 100 to perform an authorization process each time the vehicle travels ten miles in performing the transport service. In response to detecting the event, the fraud determine 150 can transmit a trigger 155 to the score compute 160 to determine an authorization amount for the transport service in association with the detected event. The score compute 160 can determine the authorization amount 161 based on a set of price parameters associated with that transport service, the location of the vehicle/driver at the time the event was detected (or just before or just after, depending on implementation), and/or the time when the event was detected (or just before or just after, depending on implementation). The authorization amount 161 can be a monetary amount or a value that corresponds to a monetary amount.

As described herein, a set of parameters can affect how the score for the transport service is to be determined or calculated. In some examples, the score can correlate to funds or monetary value. The set of parameters includes one or more of a geographic region where the transport service was initiated (e.g., different regions have different default pricing values), a vehicle type of the transport service (e.g., different vehicle types have different default pricing values), the set of default prices associated with the transport service at the time the user made the transport request 183, the price multiplier (e.g., 1× or 2.5×), etc. In the above example, the set of parameters for the transport service can specify that the fare for the transport service is calculated by a base fare amount (e.g., $3) in addition to a first rate ($1 per mile) and a second rate ($0.5 per minute). The score compute 160 can compute the authorization amount 161 by performing a calculation of a portion of the fare as of the time the event is detected (e.g., an expected value of the transport service at this point in time). For example, if the vehicle traveled ten miles and the transport service has been ongoing for eight minutes, the authorization amount 161 can be determined as $17 (e.g., $3 plus $10 plus $4 based on the set of parameters).

According to another example, the score compute 160 can estimate the authorization amount 161 based on historical data stored in the trips database 173 of previously completed transport services. The trips database 173 can store information about previously completed transport services, such as where those transport services started and ended, the routes taken, the vehicle types, the times of day, and the prices. The score compute 160 can determine a comparable previously completed transport service for the ongoing transport service to estimate the expected value of the transport service at the point in time the event was detected.

The score compute 160 can provide the authorization amount 161 to the resource manage 140, which can transmit an authorization request 145 to the payment processing system to hold an open transaction for the authorization amount 161 for the user's financial account. The payment processing system can communicate with the issuer of the user's financial account (e.g., the credit card company or bank) to communicate the request to hold the open transaction.

If the authorization succeeds, the authorization request will result in holding an open transaction with the issuer of the user's financial account for the authorization amount 161. This authorization amount 161 will be unavailable for the user to spend, thereby enabling the system 100 to secure at least this amount for the transport service when completed. The payment processing system can also provide information to the system 100 indicating that the user's financial account has sufficient funds. The transport service can continue normally (e.g., the system 100 will operate in a normal state and not transmit a notification or message to the user's device 180 or the driver device 190).

On the other hand, if the authorization fails, the authorization request will result the transaction for the authorization amount 161 not being held. In such case, the issuer of the user's financial account can communicate the information to the payment system, which can notify the system 100 that the user's financial account is insufficient or invalid (e.g., has been declined or unauthorized for use). In one example, when the fraud determine 150 receives validation information 144 indicating the invalidity of the user's financial account, the fraud determine 150 can perform additional operations (e.g., as opposed to operating in the normal state). Depending on implementation, the fraud determine 150 can transmit a message to the client device 180 instructing the user to input a new payment mechanism for paying for the transport service or instructing the user to contact support service for the entity (e.g., display a phone number or selectable feature to enable the user to make a call), and/or transmit a notification 197 to the driver device 190 instructing the driver to end the transport service at a safe location for the user. Alternatively, the fraud determine 150 can notify the dispatch 110 that the user's financial account is insufficient or invalid and the dispatch 110 can communicate respective notifications to the client device 180 and/or the driver device 190.

Depending on the conditions associated with the transport service and the specified events, the fraud determine 150 can cause the system 100 to perform no authentication processes, perform one authentication process, or perform multiple (e.g., incremental) authentication process during the course of a transport service. Because the system 100 may not be able to determine, at the start of the transport service, the total score of the transport service (when completed), by performing one or more authentication processes (for certain transport services) in connection with financial accounts, the system 100 can maintain the ability to collect at least a portion of the funds during the performance of the transport service.

As an addition or an alternative, the transport request 183 can also include a destination location data point 186 along with a pickup location data point 185. In one example, when the transport request 183 includes both a start and destination location, as part of the initial authorization process (e.g., before the transport service is arranged for the user), the fraud determine 150 and the score compute 160 can determine an estimated total score for transport service (e.g., what the total score may be when completed). The estimated score can be based, at least in part, on the start location, the destination location, an estimated route of travel, an estimated travel time, and/or the set of parameters. The fraud determine 150 can receive the estimated score from the score compute 160, for example, and triggers the resource manage 140 to initiate the initial authorization process for the user's financial account for a particular value associated with the estimated score.

As opposed to requesting an initial authorization for a small value amount, such as $0 or $1 authorization amount discussed in a prior example, the particular value can be the total estimated fare (e.g., $32) or a predetermined portion of the estimated fare (e.g., fifty percent or eighty percent of the estimated fare). In this example, by computing the estimated fare during the initial authorization process, the system 100 may forego performing other authorization processes during the course of the transport service.

### Methodology

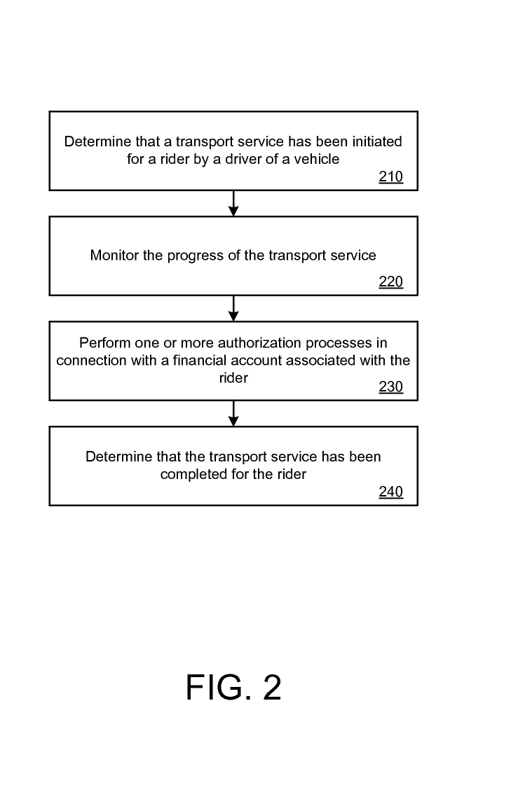

FIG. 2 illustrates an example method of performing one or more authorization processes during performance of a service, according to an embodiment. A method such as described by an example of FIG. 2 can be implemented using, for example, components described with an embodiment of FIG. 1. Accordingly, references made to elements of FIG. 1 are for purposes of illustrating a suitable element or component for performing a step or sub-step being described.

A service arrangement system, such as the system 100 of FIG. 1, can arrange a service, such as a transport service, to be provided for a rider by a driver of a vehicle. When the transport service is arranged (e.g., the driver accepts the invitation to provide the transport service for the rider), the system 100 can monitor the progress of the driver to the pickup location specified by the rider by periodically receiving driver information (e.g., status and location information) from the driver device 190. The system 100 can determine when the transport service has been initiated for the rider based, at least in part, on information received from the driver device 190 and/or the client device 180 (210).

Once the transport service has been initiated, the system 100 can monitor the progress of the transport service by periodically receiving driver information from the driver device 190 (220). In one example, monitoring the progress of the transport service can include periodically determining the current location of the driver (e.g., periodically tracking the vehicle) and periodically determining the duration of the transport service. During the progress of the transport service, the system 100 can perform one or more authorization processes in connection with a financial account associated with the rider (230). For example, the system 100 can determine that the driver has traveled a threshold distance from the start location of the transport service and/or that a threshold duration of time has elapsed since the start time of the transport service. In another example, the system 100 can determine that the amount for the fare for the transport service is accumulating at a threshold rate (e.g., $20 per 15 minutes or $80 per hour) based on the set of parameters associated with that transport service (e.g., vehicle type, price multiplier), and in response, determine that an authorization process is to be performed at a specified time (or every predetermined duration of time, 15 minutes or every 20 minutes, etc., until completion of the transport service).

Each time an authorization process is initiated, the score compute 160 can determine an authorization amount for the transport service as of the time the authorization process is initiated, and the resource manage 140 can transmit an authorization request to a payment processing system to hold an open transaction for the determined authorization amount for the rider's financial account. The resource manage 140 can receive information from the payment processing system whether or not the authorization is successful. The system 100 can perform multiple authorization processes for the transport service, based on specified rules that control the operation of the fraud determine 150, for example, until the transport service is completed for the rider. Once the system 100 determines that the transport service has been completed for the rider (e.g., based on data received from the driver device 190 and/or the client device 180) (240), the system 100 can perform a score calculation (e.g., for the total fare of the transport service) based on the monitored location data and/or time information of the transport service. The resource manage 140 can communicate with the payment processing system to request authorization for the amount of the total fare to be charged to the rider's financial account.

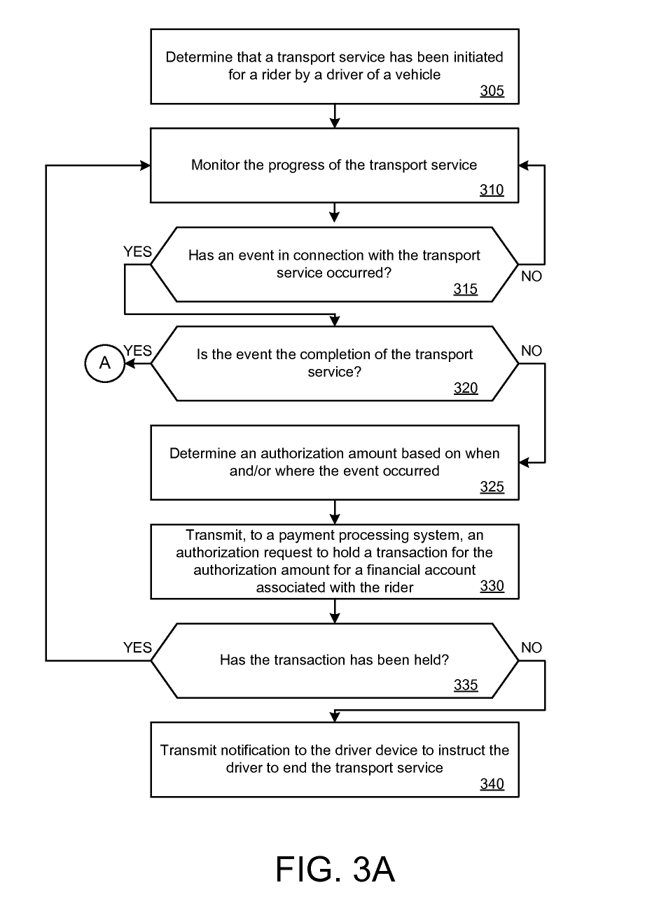

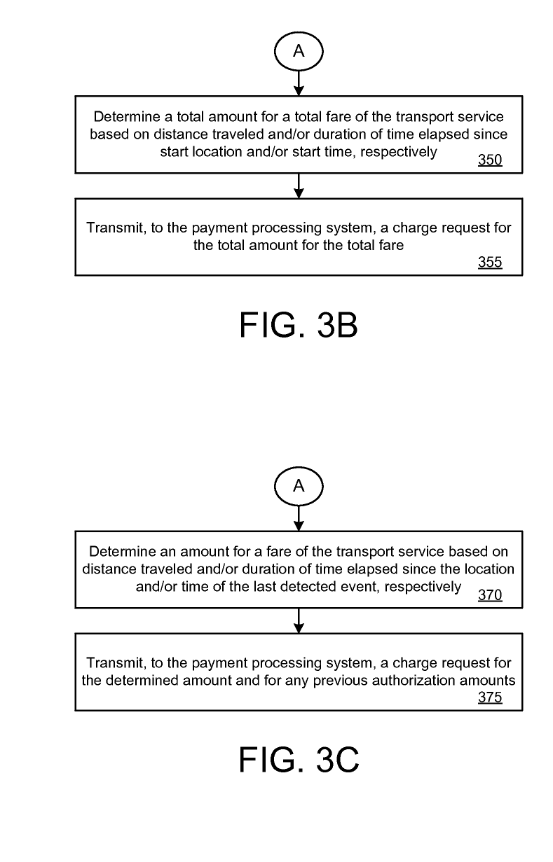

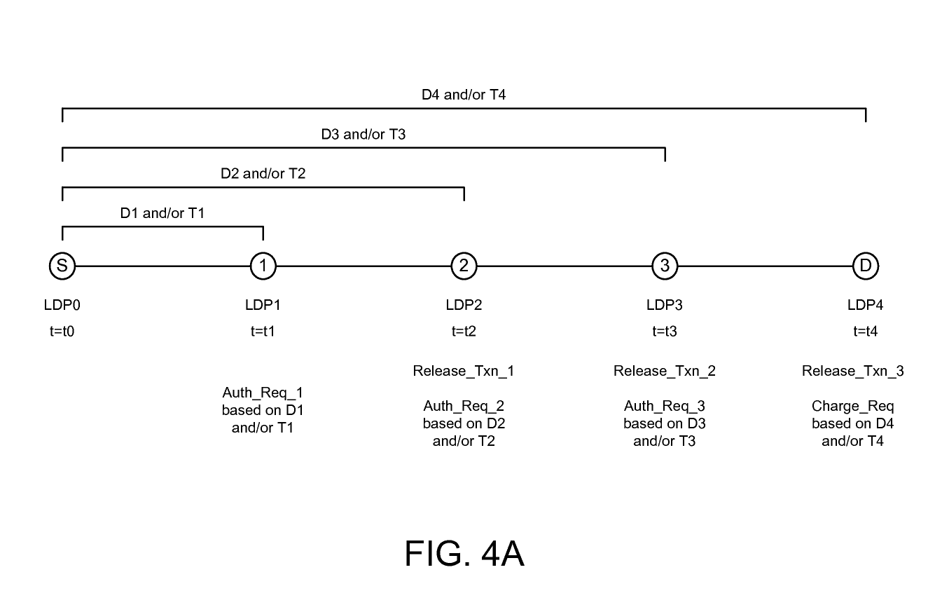

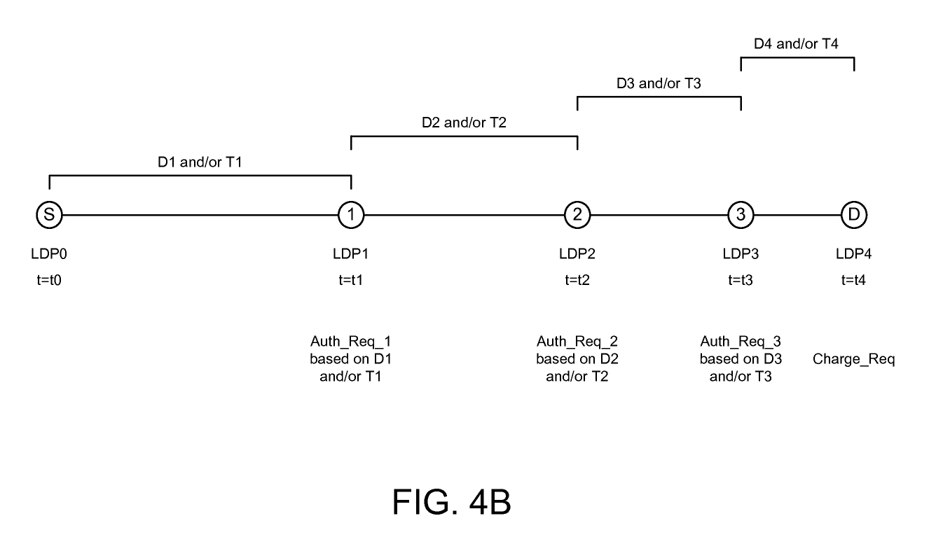

FIGS. 3A through 3C illustrate other example methods of performing one or more authorization processes during performance of a service, under an embodiment. Methods such as described by examples of FIGS. 3A through 3C can be implemented using, for example, components described with an embodiment of FIG. 1. FIGS. 4A and 4B are example diagrams illustrating authorization processes, according to embodiments. Accordingly, references made to elements of FIG. 1 are for purposes of illustrating a suitable element or component for performing a step or sub-step being described.

In one example, FIGS. 3A through 3C can illustrate a detailed method of FIG. 2. Referring to FIG. 3A, the system 100 can determine that a transport service has been initiated for a rider by a driver of a vehicle (305). For example, referring to FIG. 4A for illustrative purposes, the system 100 can determine that the transport service has started (S) having a location data point 0 (LDP0) at start time t=t0. The system 100 can have arranged the transport service for the rider by performing a driver selection process for the rider based on the information from the transport request 183. In one example, the system 100 may have already performed an initial authorization process when the transport request 183 was received from the client device 180 and received information indicating that the rider's financial account (specified to pay for the transport service when completed) is active or valid.

The system 100 can monitor the progress of the transport service (from the time the transport service is arranged to completion of the transport service) by periodically receiving driver information from the driver device 190 (310), including periodically receiving a location data point corresponding to the location of the driver device 190. The driver application 191, for example, can communicate with the Global Positioning System (GPS) receiver of the driver device 190 to periodically determine the current location of the driver device 190. During the progress of the transport service, the system 100 can detect whether an event in connection with the transport service has occurred (315). For example, the system 100 can periodically check whether any of one or more events has occurred based, at least in part, on the transport service specifics (e.g., the transport type, the pickup location region), one or more location data points received from the driver device 190 and/or time information associated with the transport service. As described herein, an event in connection with the transport service can trigger the system 100 to perform an authentication process for the rider's financial account.

According to an example, an event can correspond to the transport service being completed. In such an example, if an event is detected, the system 100 can determine whether the detected event corresponds to the completion of the transport service (320). If the event does not correspond to the completion the transport service, the system 100 can determine that an authorization process is to be performed for the rider's financial account. The system 200 can determine an authorization amount based on when and/or where the event occurred (325). Alternatively, in FIG. 3A, the method can omit step 320, so that if an event is detected at step 315, the system 100 can determine an authorization amount at step 325.

For example, referring to FIG. 4A, the system 100 can detect an event (1) that occurs at time t=t1 (subsequent to t=t0) and/or that occurs based on the driver being positioned at LDP1. At this point, the driver may have traveled a distance D1 from the start location, LDP0, to the location, LDP1, and the duration of time, T1, may have elapsed since the start of the transport service. The system 100 can then determine an authorization amount for the transport service at this point based, at least in part, on D1 and/or T1, and a set of parameters associated with the transport service (e.g., the vehicle type, the current price multiplier, the default price associated with per distance, per time, or flat rate, etc.). This authorization amount can be the expected value of the transport service as of the time the event (1) was detected (e.g., $10). The system 100 can then transmit, to a payment processing system, an authorization request, Auth_Req_1, to hold an open transaction for the amount (e.g., $10) for the rider's financial account (330).

The system 100 can receive information from the payment processing system that indicates whether the transaction has been held or not (or respectively, whether the authorization request was successful or not) (335). For example, if the authorization request fails, the rider's financial account has insufficient funds or has been marked or flagged as being stolen since the last time the rider's financial account was verified to be valid by the system 100. If the authorization request fails, the system 100 can receive information indicating that the rider's financial account is invalid or has insufficient funds. The system 100 can, in response, transmit a notification to the driver application 191 of the driver device 190, which instructs the driver to drop off the rider at the closest safe stop and/or end the transport service (340). The notification can be displayed as part of a user interface feature of the driver application 191 that includes a selectable feature to enable the driver to select in order to indicate that the transport service has ended. As an addition or an alternative, the system 100 can transmit a notification to the client application 181 of the client device 180, which notifies the rider that the rider's financial account is invalid and to input a new payment mechanism. The notification can provide a decreasing timer that indicates an amount of time the rider has to input a new payment mechanism that is to be validated (e.g., provide the new payment mechanism information within three minutes).

On the other hand, if the authorization request succeeds, the rider's financial account is valid and/or has sufficient funds (e.g., at least $7) for the transaction to be held. The system 100 can continue to monitor the progress of the transport service (310) and continued to detect whether an event has occurred in connection with the transport service (315). Referring to FIG. 4A, the system 100 can detect a second event (2) when a distance threshold and/or time threshold is reached. For example, the second event (2) occurs at time t=t2 (subsequent to t=t1) and/or occurs based on the driver being positioned at LDP2. At this point, the driver may have traveled a distance D2 from the start location, LDP0, to the location, LDP2, and the duration of time, T2, may have elapsed since the start of the transport service. Alternatively, the system 100 can detect that the second event occurred when a threshold distance was traveled by the driver since the last detected event (e.g., the threshold distance can be the distance D2 minus D1) and/or when a threshold duration of time (e.g., T2 minus T1) has passed since the last detected event.

The system 100 can then determine an authorization amount for the transport service at this point based, at least in part, on D2 and/or T2, and the set of parameters associated with the transport service. This authorization amount can be the expected value of the transport service as of the time the event (2) was detected (e.g., $23). In addition, in the example of FIG. 4A, before or concurrently while transmitting the authorization request to the payment processing system (step 330), the system 100 can transmit a release request, Release_Txn_1, to the payment processing system to request that the previously held transaction be released. The system 100 can transmit the authorization request, Auth_Req_2, to the payment processing system to hold an open transaction for the second authorization amount ($23) associated with the second event for the rider's financial account. By releasing the previous amount (e.g., $10), the system 100 can avoid multiple transactions from being held with the rider's financial account.

In the example of FIG. 4A, the system 100 (i) detects another additional event (3), (ii) determines the authorization amount associated with the event (3) (e.g., $38) based on D3 and/or T3, (iii) transmits a release request, Release_Txn_2, to the payment processing system to request that the previously held transaction be released, and (iv) transmits an authorization request, Auth_Req_3, to the payment processing system to hold an open transaction for the third authorization amount ($38) associated with the third event for the rider's financial account. The system 100 then detects, at time t=t4, that the transport service has been completed at the destination (D) having the location data point, LDP4 (step 320).

According to an example of FIG. 3B, in response to determining that the transport service has completed, the system 100 can determine a total amount of the total fare of the transport service based on the distance traveled and/or the duration of time elapsed since the start location and/or start time, respectively (350). Referring to FIG. 4A, the total amount of the total fare can be based on D4 and/or T4. In addition, the system 100 can transmit a release request, Release_Txn_3, to request that the previously held transaction be released. The system 100 can transmit, to the payment processing system, a charge request for the total amount for the total fare (e.g., $55) for the entirety of the completed transport service (355). In such an example, by transmitting a charge request, the system 100 can request that the total amount be held for the rider's financial account and be transferred to an account associated with the system 100 (or the driver's account).

Alternatively, as opposed to requesting releases for transactions previously held for the rider's financial account, such as described in the example of FIG. 4A, in some examples, the system 100 can let the held transactions stack (or continue to be held), such as illustrated in FIG. 4B. FIG. 4B illustrates the system 100 performing the authentication processes more frequently as the accumulated amount of the transport service increases (e.g., perform more checks as the expected fare increases). In addition, FIG. 4B illustrates the system 100 allowing the previous held transactions to remain for the rider's financial account.

Referring to FIG. 4B, the system 100 can detect that the transport service has started (S) at time t=t0 and at the location data point, LDP0. The system 100 can detect an event (1) at time t=t1 and/or at location data point, LDP1. In response, the system can perform the authorization process for the rider's financial account (e.g., steps 325 through 335 of FIG. 3A), resulting in holding an open transaction for the authorization amount associated with the first event (e.g., $12). This authorization amount can be based on D1 and/or T1 and the set of parameters associated with the transport service.

The system 100 can then detect another event, such as event (2), as illustrated in FIG. 4B. Depending on examples, the second event can be detected when the system 100 determines that the driver has traveled a threshold distance from the start location (e.g., D1 plus D2) and/or a threshold duration of time has elapsed from the start time (e.g., T1 plus T2), or when the system 100 determines that the driver has traveled a threshold distance from the previous location associated with the previous event (e.g., D2) and/or a threshold duration of time has elapsed from the previous time when the previous event was detected (e.g., T2). When the system 100 detects an event (2) at time t=t2 and/or at location data point, LDP2, the system 100 can again perform authorization process. In this example, the system 100 does not transmit a release request to the payment processing system to release the previous held transaction. Instead, the system can determine an authorization amount associated with the second event based on D2 and/or T2 and the set of parameters associated with the transport service (e.g., $9). If the rider's financial account is validated, two transactions can be held with the rider's financial account, one for $12 and one for $9.

According to this example, when the system 100 determines that the transport service has been completed at time t=t4 and at location data point, LDP4, the system 100 can determine the amount for the fare of the transport service based on the distance traveled and/or the duration of time elapsed since the previous location and/or previous time of the last detected event, e.g., event (3) (370 of FIG. 3C). This amount (e.g., $6) can correspond to the last portion of the transport service that has not yet been charged since the last held transaction. As described in the example of FIG. 3C, system 100 can determine the amount based on D4 and/or T4, as well as the set of parameters, and transmit, to the payment processing system, a charge request for this determined amount ($6) and for all the previous held transaction amounts (e.g., $12, $9, and $8 for the third authorization amount associated with the third event, for a total of $35) (375). In this manner, the total amount can correspond to the total fare of the transport service.

### Hardware Diagrams

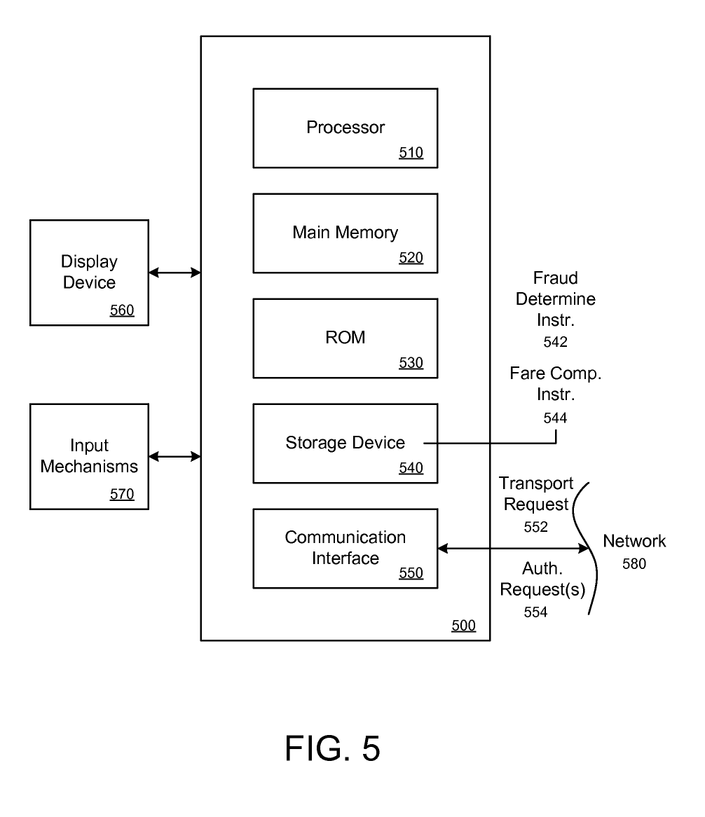

FIG. 5 is a block diagram that illustrates a computer system upon which embodiments described herein may be implemented. For example, in the context of FIG. 1, the system 100 may be implemented using a computer system such as described by FIG. 5. The system 100 may also be implemented using a combination of multiple computer systems as described by FIG. 5.

In one implementation, a computer system 500 includes processing resources 510, a main memory 520, a read only memory (ROM) 530, a storage device 540, and a communication interface 550. The computer system 500 includes at least one processor 510 for processing information and the main memory 520, such as a random access memory (RAM) or other dynamic storage device, for storing information and instructions to be executed by the processor 510. The main memory 520 also may be used for storing temporary variables or other intermediate information during execution of instructions to be executed by the processor 510. The computer system 500 may also include the ROM 530 or other static storage device for storing static information and instructions for the processor 510. A storage device 540, such as a magnetic disk or optical disk, is provided for storing information and instructions, including fraud determine instructions 542, score compute instructions 544, and other instructions, such as dispatch instructions.

For example, the processor 510 can execute the fraud determine instructions 542 to implement logic for determining which user accounts, if any, are potentially fraudulent user accounts and determining when to cause the computer system 500 to perform authorization processes during a transport service, such as described in FIGS. 1 through 4B. Such user accounts can be stored in the storage device 540 and/or in other storage devices accessible by the computer system 500. The processor 510 can execute the score compute instructions 544 to implement logic for determining authorization amounts during the transport service, and also execute the dispatch instructions to implement logic for processing requests and selecting service providers for users, such as described in FIGS. 1 through 4B.

The communication interface 550 can enable the computer system 500 to communicate with one or more networks 580 (e.g., cellular network) through use of the network link (wireless or wireline). Using the network link, the computer system 500 can communicate with one or more other computing devices and/or one or more other servers or datacenters. In some variations, the computer system 500 can receive a transport request 552 from a client device of a user via the network link. The transport request 552 can include the user's user ID or device ID, a requested pickup location data point, a destination location data point, and/or a vehicle type selection. The processor 510, through execution of instructions, can arrange the transport service for the user, determine when to perform an authorization process for a user's financial account during the course of the transport service. The processor 510, through execution of instructions, can also transmit an authorization request 554 to a payment processing system, such as described in FIGS. 1 through 4.

The computer system 500 can also include a display device 560, such as a cathode ray tube (CRT), an LCD monitor, or a television set, for example, for displaying graphics and information to a user. One or more input mechanisms 570, such as a keyboard that includes alphanumeric keys and other keys, can be coupled to the computer system 500 for communicating information and command selections to the processor 510. Other non-limiting, illustrative examples of input mechanisms 570 include a mouse, a trackball, touch-sensitive screen, or cursor direction keys for communicating direction information and command selections to the processor 510 and for controlling cursor movement on the display 560.

Examples described herein are related to the use of the computer system 500 for implementing the techniques described herein. According to one embodiment, those techniques are performed by the computer system 500 in response to the processor 510 executing one or more sequences of one or more instructions contained in the main memory 520. Such instructions may be read into the main memory 520 from another machine-readable medium, such as the storage device 540. Execution of the sequences of instructions contained in the main memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

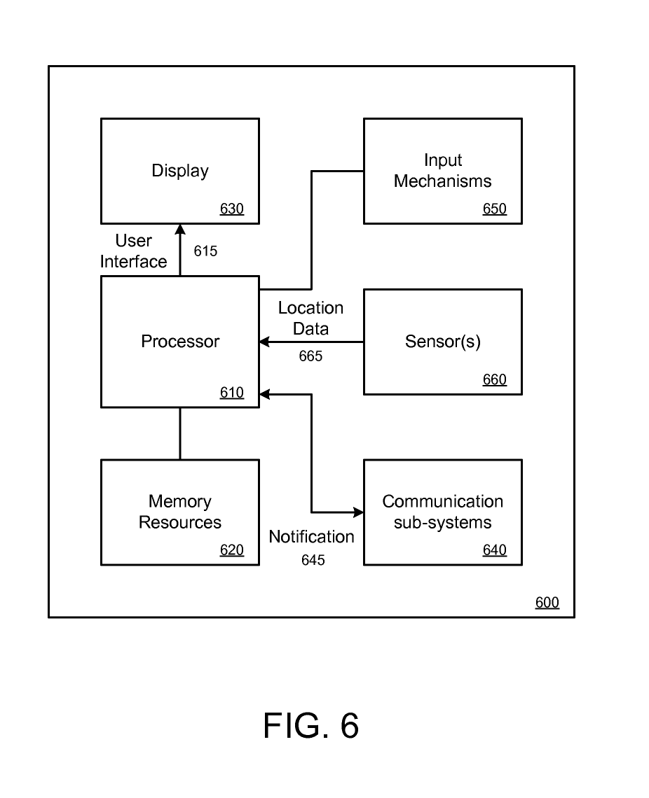

FIG. 6 is a block diagram that illustrates a mobile computing device upon which embodiments described herein may be implemented. In one embodiment, a computing device 600 may correspond to a mobile computing device, such as a cellular device that is capable of telephony, messaging, and data services. The computing device 600 can correspond to a client device or a driver device. Examples of such devices include smartphones, handsets or tablet devices for cellular carriers. The computing device 600 includes a processor 610, memory resources 620, a display device 630 (e.g., such as a touch-sensitive display device), one or more communication sub-systems 640 (including wireless communication sub-systems), input mechanisms 650 (e.g., an input mechanism can include or be part of the touch-sensitive display device), one or more sensors 660, including a location detection mechanisms (e.g., GPS receiver), and a camera (not shown in FIG. 6). In one example, at least one of the communication sub-systems 640 sends and receives cellular data over data channels and voice channels.

The processor 610 can provide a variety of content to the display 630 by executing instructions and/or applications that are stored in the memory resources 620. For example, the processor 610 is configured with software and/or other logic to perform one or more processes, steps, and other functions described with implementations, such as described by FIGS. 1 through 5, and elsewhere in the application. In particular, in one example, the processor 610 can execute instructions and data stored in the memory resources 620 in order to operate a driver service application, as described in FIGS. 1 through 5. Still further, the processor 610 can cause one or more user interfaces 615 to be displayed on the display 630, such as one or more user interfaces provided by the driver service application.

A driver can operate the computing device 600 to operate the driver service application in order to receive an invitation for a transport service. The driver service application can also communicate with the sensor(s) to determine location data 665 corresponding to the current location of the computing device 600. For example, the computing device 600 can periodically determine a location data point 665 of the current location and provide the location data point 665 to the transport arrangement system (not shown in FIG. 6). The transport arrangement system can provide communications to the computing system 600 via the communication sub-systems 640. If the transport arrangement system determines, as part of an authorization process, that a user's financial account is invalid or has insufficient funds, it can transmit a notification 645 to the computing device 600, instructing the driver to end the transport service. The driver service application can display, as part of a user interface 615, a message that instructs the driver to drop off the user at a safe location and end the transport service. While FIG. 6 is illustrated for a mobile computing device, one or more examples may be implemented on other types of devices, including full-functional computers, such as laptops and desktops (e.g., PC).

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is being claimed is:

1. A method of monitoring transport, the method being performed by a computing system and comprising:
determining, at the computing system, that a transport has been initiated for a rider by a driver of a vehicle;
during progress of the transport service:
receiving, at the computing system, location data points from a computing device associated with one of the rider or driver as the transport progresses;
in response to detecting the occurrence of the event, determining a score for at least a portion of the transport based, at least in part, on a set of parameters associated with the transport service, the set of parameters including (i) a set of received location data points, or (ii) an elapsed amount of time since the initiation of the transport service; and
performing an authorization action exclusively for the portion of the of the transport.

2. The method of claim 1, further comprising detecting the occurrence of the event by determining that at least a threshold distance has been traveled by the vehicle or a threshold duration of time has elapsed since the transport was initiated.

3. The method of claim 1, wherein the set of parameters includes one or more of (i) a geographic region where the transport was initiated, (ii) a vehicle type associated with the transport, (iii) a set of weights or authorization values for determining the score, the set of weights being associated with the transport at a time the rider made a request for the transport, or (iv) a set of weights or authorization values associated with the transport service at a time the transport was initiated.

4. The method of claim 3, wherein determining the score includes computing the score as of a time the event was detected based on one or more of (i) a distance traveled by the vehicle from a start location of the transport service to a location of the vehicle at the time the event was detected, or (ii) a duration of time elapsed from a start time of the transport to the time the event was detected.

5. The method of claim 3, wherein determining the score includes estimating a total score for the transport as of a time the event was detected based on a set of historic data that is associated with the geographic region where the transport was initiated and the vehicle type associated with the transport service.

6. The method of claim 1, wherein performing the authorization action includes sending an authorization request a remote authorization source, and wherein transmitting the authorization request includes transmitting, along with or as part of the authorization request, an identifier associated with the rider to enable the authorization source to identify the rider.

7. The method of claim 6, further comprising:
during progress of the transport, receiving, from the authorization source, information declining authorization; and
in response to receiving the information, transmitting, to the computing device operated by the driver, a message instructing the driver to end the transport for the rider.

8. The method of claim 1, further comprising detecting, at the computing system, the occurrence of the event in connection with the transport service based on one or more of (i) a set of received location data points, or (ii) an elapsed amount of time since the initiation of the transport service.

9. A non-transitory computer-readable medium storing instructions that, when executed by one or more processors of a computing system, cause the computing system to:
determine, at the computing system, that a transport service has been initiated for a rider by a driver of a vehicle;
during progress of the transport service:
periodically receive, at the computing system, location data points from a computing device operated by the rider or a computing device operated by the driver until completion of the transport service;
detect, at a first time, an occurrence of a first event in connection with the transport service based on one or more of (i) a first set of received location data points, or (ii) an elapsed amount of time since the initiation of the transport service;
in response to detecting the occurrence of the first event, determine a first authorization amount for the transport service based, at least in part, on a set of parameters associated with the transport service;
transmit, from the computing system to a payment processing system, a first authorization request to hold a first transaction for the first authorization amount for a financial account associated with the rider before completion of the transport service;
receive, from the payment processing system, information indicating that the first transaction for the first authorization amount has been held for the financial account;
detect, at a second time subsequent to the first time, an occurrence of a second event in connection with the transport service based on one or more of (i) a second set of received location data points, or (ii) an elapsed amount of time since the initiation of the transport service or since the occurrence of the first event;
in response to detecting the occurrence of the second event, determine a second authorization amount for the transport service based, at least in part, on a set of parameters associated with the transport service;
transmit, from the computing system to a payment processing system, a second authorization request to hold a second transaction for the second authorization amount for the financial account associated with the rider before completion of the transport service; and
determining, at the computing system, that the transport service has been completed for the rider.

10. The non-transitory computer-readable medium of claim 9, wherein the instructions cause the computing system to detect the occurrence of the first event by determining that at least a first threshold distance has been traveled by the vehicle or a first threshold duration of time has elapsed since the transport service had initiated.

11. The non-transitory computer-readable medium of claim 10, wherein the instructions cause the computing system to detect the occurrence of the second event by determining that at least a second threshold distance has been traveled by the vehicle or a second threshold duration of time has elapsed since the transport service had initiated or since the occurrence of the first event.

12. The non-transitory computer-readable medium of claim 9, wherein the set of parameters includes one or more of (i) a geographic region where the transport service was initiated, (ii) a vehicle type associated with the transport service, (iii) a set of prices associated with the transport service at a time the rider made a request for the transport service, or (iv) a set of prices associated with the transport service at a time the transport service was initiated.

13. The non-transitory computer-readable medium of claim 12, wherein the instructions cause the computing system to determine the first authorization amount by computing a first amount for a first fare of the transport service as of a time the first event was detected based on one or more of (i) a distance traveled by the vehicle from a start location of the transport service to a location of the vehicle at the time the first event was detected, or (ii) a duration of time elapsed from a start time of the transport service to the time the first event was detected.

14. The non-transitory computer-readable medium of claim 13, wherein the instructions cause the computing system to determine the second authorization amount by computing a second amount for a second fare of the transport service as of a time the second event was detected based on one or more of (i) a distance traveled by the vehicle from the start location of the transport service to a location of the vehicle at the time the second event was detected, or (ii) a duration of time elapsed from the start time of the transport service to the time the second event was detected.

15. The non-transitory computer-readable medium of claim 14, wherein the instructions cause the computing system to:
subsequent to detecting the occurrence of the second event and during progress of the transport service, transmit, from the computing system to the payment processing system, a release request to release the first transaction for the first authorization amount for the financial account associated with the rider.

16. The non-transitory computer-readable medium of claim 15, wherein the instructions cause the computing system to:
in response to determining that the transport service has been completed for the rider, compute a total amount for a total fare of the transport service based on one or more of (i) a distance traveled by the vehicle from a start location of the transport service to an end location of the vehicle where the transport service was determined to be completed, or (ii) a duration of time elapsed from a start time of the transport service to an end time when the transport service was determined to be completed; and
transmit, from the computing system to the payment processing system, (i) a second release request to release the second transaction for the second authorization amount for the financial account associated with the rider, and (ii) a charge request for the total amount from the financial account associated with the rider.

17. The non-transitory computer-readable medium of claim 13, wherein the instructions cause the computing system to determine the second authorization amount by computing a second amount for a second fare of the transport service based on one or more of (i) a distance traveled by the vehicle from the location of the vehicle at the time the first event was detected to a location of the vehicle at a time the second event was detected, or (ii) a duration of time elapsed from the time the first event was detected to a time the second event was detected.

18. The non-transitory computer-readable medium of claim 17, wherein the instructions cause the computing system to:
in response to determining that the transport service has been completed for the rider, compute a third amount for a third fare of the transport service based on one or more of (i) a distance traveled by the vehicle from the location of the vehicle at the time the second event was detected to an end location of the vehicle where the transport service was determined to be completed, or (ii) a duration of time elapsed from the time the second event was detected to an end time when the transport service was determined to be completed; and
transmit, from the computing system to the payment processing system, a charge request for the first authorization amount, the second authorization amount, and the third amount from the financial account associated with the rider.

19. The non-transitory computer-readable medium of claim 9, wherein the payment processing system is remote from the computing system and stores data associated the financial account associated with the rider, and wherein the instructions cause the computing device to transmit the first authorization request by transmitting, along with or as part of the first authorization request, an identifier associated with the rider to enable the payment processing system to identify the financial account associated with the rider.

20. A method of authorizing an account in connection with a transport service, the method being performed by a computing system and comprising:
determining, at the computing system, that a transport service has been initiated for a rider by a driver of a vehicle;
during progress of the transport service:
periodically receiving, at the computing system, location data points from a computing device operated by the rider or a computing device operated by the driver until completion of the transport service;
detect, at a first time, an occurrence of a first event in connection with the transport service based on one or more of (i) a first set of received location data points, or (ii) an elapsed amount of time since the initiation of the transport service;
in response to detecting the occurrence of the first event, determine a first authorization amount for the transport service based, at least in part, on a set of parameters associated with the transport service;
transmit, from the computing system to a payment processing system, a first authorization request to hold a first transaction for the first authorization amount for a financial account associated with the rider before completion of the transport service;
receiving, from the payment processing system, information indicating that the first transaction for the first authorization amount has been held for the financial account;
detect, at a second time subsequent to the first time, an occurrence of a second event in connection with the transport service based on one or more of (i) a second set of received location data points, or (ii) an elapsed amount of time since the initiation of the transport service or since the occurrence of the first event;
in response to detecting the occurrence of the second event, determine a second authorization amount for the transport service based, at least in part, on a set of parameters associated with the transport service;
transmit, from the computing system to a payment processing system, a second authorization request to hold a second transaction for the second authorization amount for the financial account associated with the rider before completion of the transport service; and
determining, at the computing system, that the transport service has been completed for the rider.
